(19) United States
(12) Patent Application Publication
(10) Pub. No.: US 2008/0149618 A1
(43) Pub. Date: Jun. 26, 2008

(54) Household sectional oven and warmer cooking apparatus

(76) Inventor: Tseng Chung-Ting, Taipei (TW)

Correspondence Address: TROXELL LAW OFFICE PLLC, 5205 LEESBURG PIKE, SUITE 1404, FALLS CHURCH, VA, 22041, US

(21) Appl. No.: 11/583,685

(22) Filed: Oct. 20, 2006

(51) Int. Cl. A21B 1/00

(52) U.S. Cl. 219/393

(57) ABSTRACT

A household sectional oven and warmer cooking apparatus includes an electric heating device with a switch for controlling the heating temperature and time of an oven. The apparatus further includes openings at the top and lateral sides of the oven for carrying a hotdog broiler composed of parallel cylinders or a basket with a meat slice and bread baking pan embedded into the periphery of the opening and a first and second door panel for covering the openings of the oven.

### FIELD OF THE INVENTION

The present invention relates to a household sectional oven and warmer cooking apparatus, more particularly to a household cooking apparatus having several cooking utilities designed for cooking or warming a hotdog and a bun, such that the hotdog or meat slice can be added into the bun and the bun can be kept warm to solve the problem of requiring different temperatures for cooking and warming different food items. The cooking apparatus comprises: an electric heating device controlled by a switch for controlling the heating temperature and time of an oven; openings disposed at the top and the lateral sides of the oven, such that the opening at the top of the oven or the lateral sides of the oven can carry a hotdog broiler composed of a plurality of parallel cylinders with an appropriate distance apart from each other or a basket; a meat slice and bread baking pan in a net shape embedded or inserted into the periphery of the opening or in a casing; and a cover for covering the whole oven and warmer apparatus and keeping the apparatus warm. Such arrangement allows users to install the meat slice and bread baking pan and the hotdog broiler onto the oven quickly, conveniently and flexibly to meet different heat supplies and heating methods required for different food items, and the electric heating device maintains an appropriate distance or a partition from each cooking food item to avoid the food from being burned and achieve the purpose of heating and warming the food appropriately. The overall structure is simple, low-cost, and easy-to-clean, which constitutes an economic convenient household cooking apparatus.

### BACKGROUND OF THE INVENTION

Among various different fast foods, hotdog made of putting meat slices into a bun is a common favorite fast food to most people, particularly children. In addition, hotdog stands are available almost everywhere such as a shopping mall and a superstore, etc, and thus making hotdog an easily available common fast food. However, a general household cooking apparatus is insufficient to make hotdogs. For simplicity and convenience, people at home usually use a pan or an oven to cook and heat hotdogs directly, but the heat supply and the heating method for cooking or warming hotdogs, buns, and meat slices are different. Therefore, heating these food items directly by contacting the bottom of a pan cannot give a good result, since the temperature of the heat is uneven, and thus the hotdog or the bun usually gets burned very often. If several cooking apparatuses are used concurrently for cooking and warming different food items, users may be confused. If different food items are cooked at different time, it will have the issue of keeping the cooked food warm. Therefore, an improvement is made as disclosed in U.S. Pat. No. 6,838,644 issued to the inventor of the present invention, but such patented invention still cannot provide an easy way for cleaning the hotdog broiler and a sufficient space for cooking hotdogs, bread and meat slices. As a result, the cylinders of the hotdog broiler cannot be rotated or the hotdogs may be heated unevenly or burned, and the traditional way of cooking hotdogs demands further improvements.

### SUMMARY OF THE INVENTION

In view of the shortcomings of the prior art, the inventor of the present invention based on years of experience on the production and design of household kitchenware to conduct researches and experiments to overcome the foregoing shortcomings and look for an improved method, and finally invented the household sectional oven and warmer cooking apparatus in accordance with the present invention.

The primary objective of the present invention is to provide a household sectional oven and warmer cooking apparatus, which comprises: an electric heating device disposed therein and controlled by a switch for controlling the heating temperature and time of an oven; openings disposed at the top and the lateral sides of the oven, such that the opening at the top or the lateral sides of the oven carries a hotdog broiler composed of a plurality of parallel cylinders disposed with an appropriate distance apart from each other or a basket; a meat slice and bread baking pan in a net shape embedded or inserted into the periphery of the opening or a casing, and a door panel for covering the whole oven and warmer apparatus and keeping the oven and warmer apparatus warm. Such arrangement allows users to install the meat slice and bread baking pan and the hotdog broiler onto the oven quickly, conveniently and flexibly to meet different heat supplies and heating methods required for different food items, and the electric heating device and each cooking food item are kept with an appropriate distance apart and partitions to avoid the food from being burned and achieve the purpose of heating and warming the food appropriately. The overall structure can achieve the effect of currently and appropriately heating and warming different food items.

The secondary objective of the present invention is to provide a household sectional oven and warmer cooking apparatus, which installs the electric heating device at each cylinder of the hotdog broiler, and the electric heating device can be electrically connected to an internal circuit in the casing from a lateral side after the electric heating device is embedded into the casing, such that heat energy can be generated from the cylinders for heating when the switch is turned on, so as to achieve an overall simple and cost-effective structure.

### BRIEF DESCRIPTION OF THE DRAWINGS

FIG. 1 is a perspective exploded view of a first preferred embodiment of the present invention;

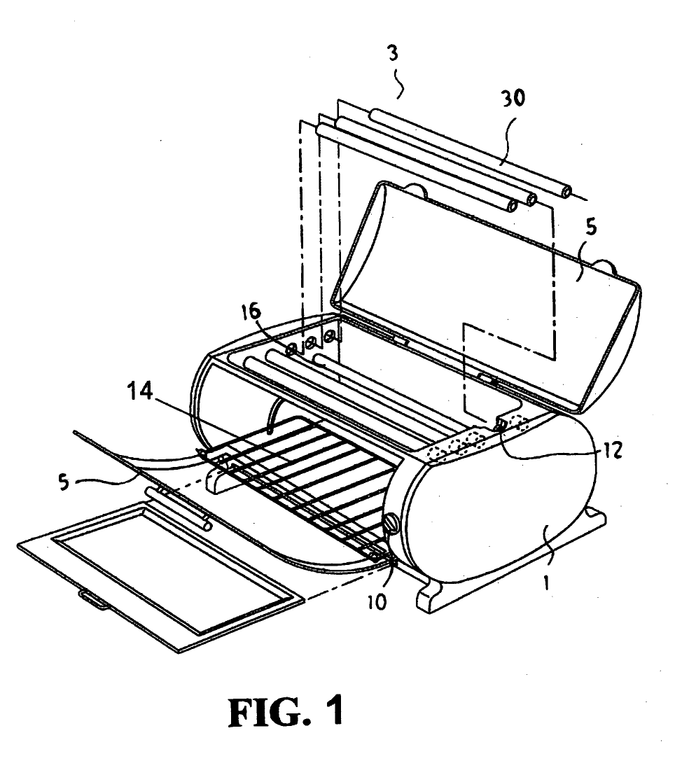

FIG. 2 is a perspective exploded view of a second preferred embodiment of the present invention;

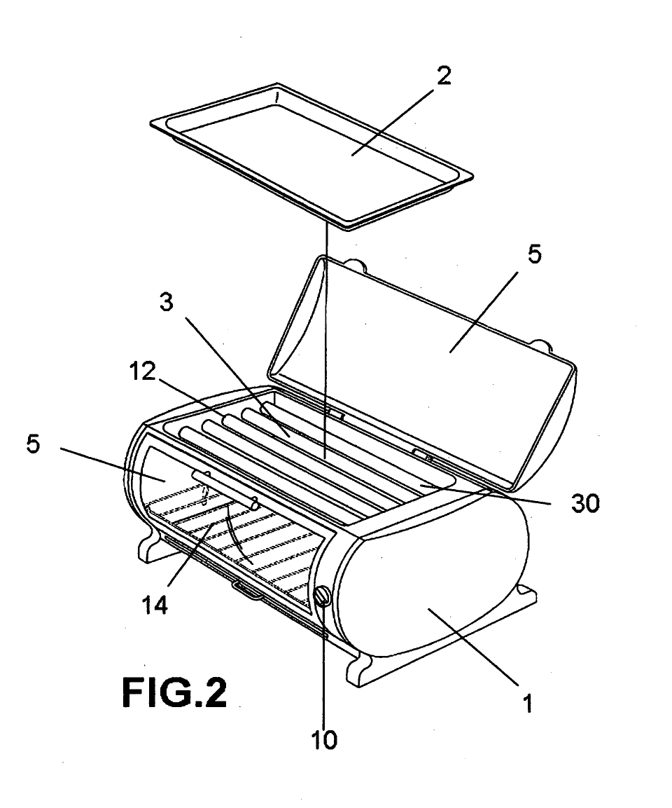

FIG. 3 is a perspective exploded view of a third preferred embodiment of the present invention;

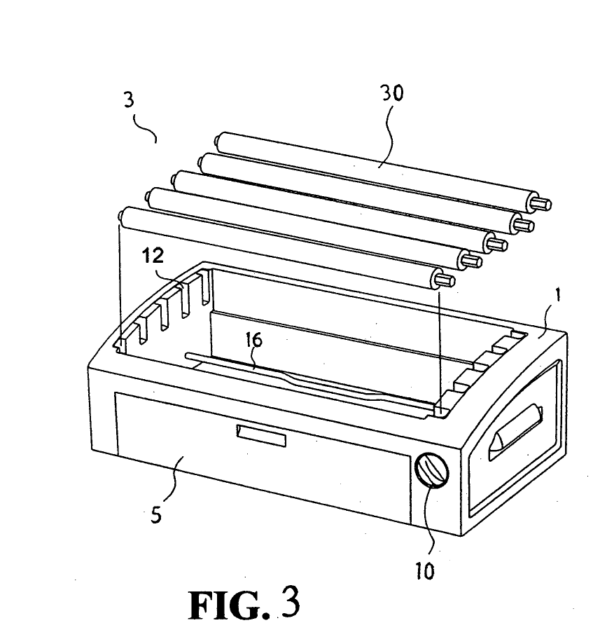

FIG. 4 is a perspective view of FIG. 3.

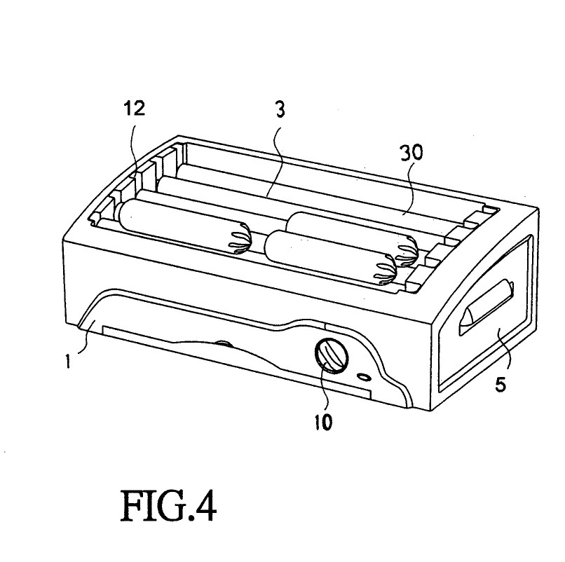

FIG. 5 is a perspective view of another preferred embodiment of FIG. 3;

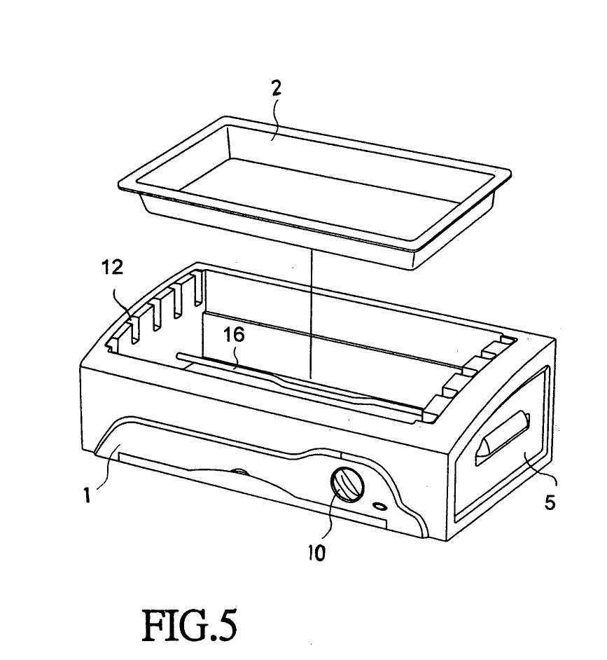

FIG. 6 is a perspective view of a further preferred embodiment of FIG. 3;

FIG. 7 is a perspective view of a preferred embodiment of FIG. 6;

FIG. 8 is a perspective view of a fourth preferred embodiment of the present invention; and

FIG. 9 is an exploded view of a fifth preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

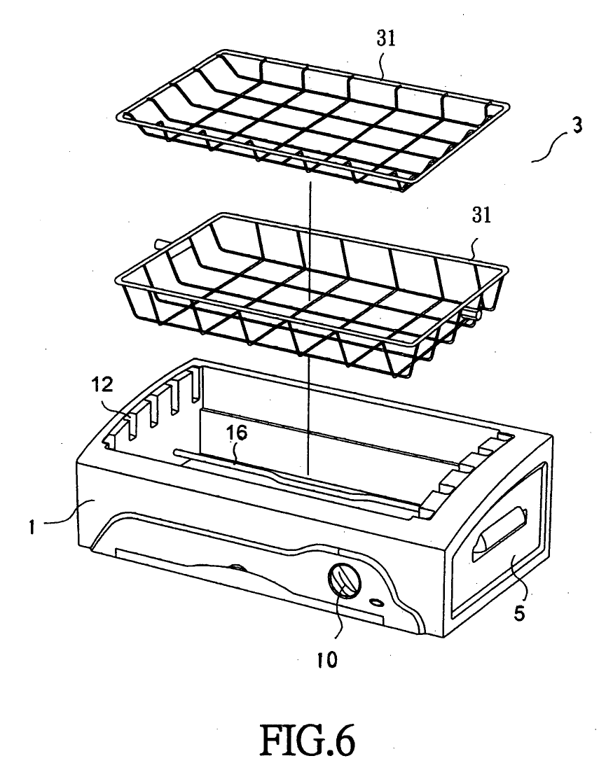

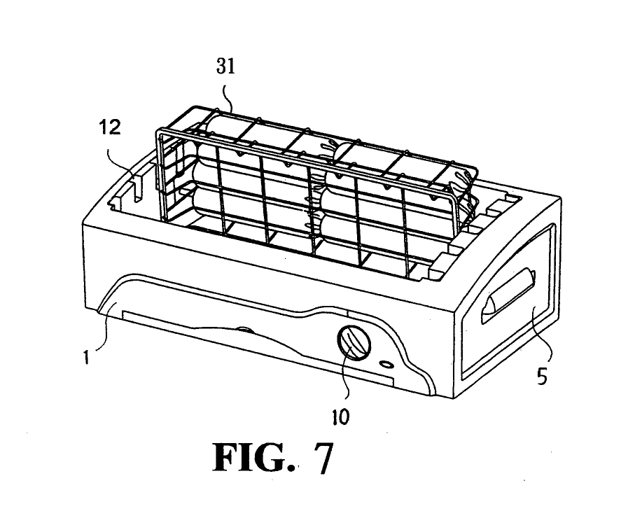

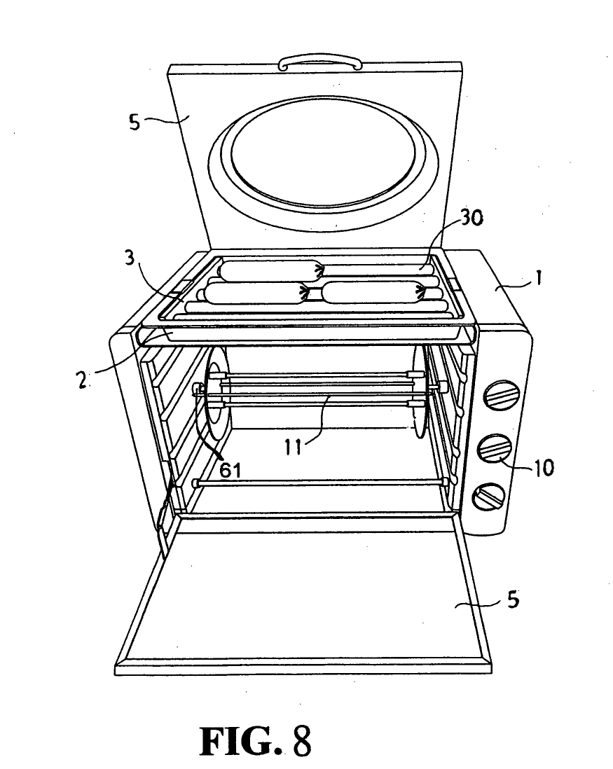

Referring to the figures, the present invention comprises an oven 1, a meat slice and bread baking pan 2, a hotdog broiler 3, a door panel 4; wherein the oven 1 comprises: an electric heating device 16 disposed therein and controlled by a switch 10 for controlling the heating temperature and time of the oven; opening disposed at the top and lateral sides of the oven 1; a plurality of cylinders embedded into an embedded groove or a flexible embedding hole 12 at the periphery of the opening at the top of the oven, such that the parallel cylinders 30 are disposed with an appropriate distance from each other to form a removable and rotatable hotdog broiler, and the meat slice and bread baking pan 2 or a grid 14 can be embedded or inserted into the periphery of the opening or into a casing; and a door panel 4 for covering and insulating the whole oven and warmer apparatus and keeping it warm. The hotdog broiler 3 as shown in FIGS. 6 and 7 could be embedded into an embedded groove 13 at the periphery of the opening or into an elastic embedding hole 12, or a rotary basket hotdog rack 31 is embedded, and the oven 1 as shown in FIG. 8 has a spiked rod 11 for inserting a hotdog or a slice of meat. If needed, the spiked rod 11 or the basket hotdog rack 31 can be rotated by means of a motor 6 that drives the cylinder 30, the spike rod 11 or the basket hotdog rack 31 to rotate through a gear 60 or an axle 61. Further, the electric heating device 16 can be installed directly in each cylinder 30 of the hotdog broiler 3, such that after the electric heating device 16 is embedded into the embedded groove or elastic embedding hole 12, the electric heating device 16 is electrically connected to an internal circuit in the casing from a lateral side, and heat energy can be produced directly from the cylinders 30 when the switch is turned on.

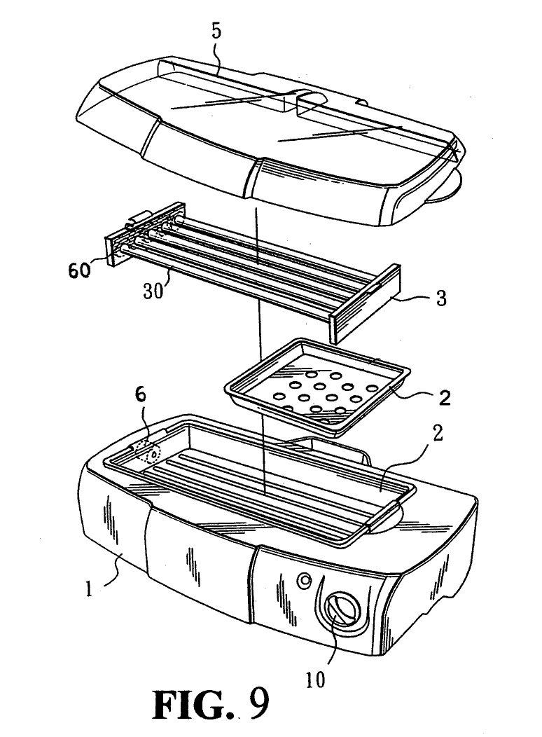

In the practical use of the cooking apparatus of the present invention, users can flexibly install the meat slice and bread baking pan 2, the grid 14, and the basket hotdog rack 31, the spike rod 11 and the hotdog broiler 3 onto the oven 1 according to the type of their desired food items to cope with different required heat supplies and heating methods. Meat slices, potatoes, or pizzas can be put into the meat slice and bread baking pan 2, the grid 14, the basket hotdog rack 31 or the spiked rod 11 for grilling, baking or heating. The hotdogs are put into the hotdog broiler 3 for heating, such that the electric heating device 19 maintains an appropriate distance and a partition from different cooking food items. With the rotating cylinders 30, basket hotdog rack 31 and spiked rod 11, the required heat supply and heating method are provided to fit different cooking food items and avoid burning or uneven heating. The switch 10 is provided for controlling and adjusting the heating temperature and time, so that the same cooking apparatus can concurrently provide the functions for baking, cooking and warming different food items. Users no longer have the problems of acting with confusions or keeping different items warmed at the same time. Besides manually turning the cylinder 30 or the basket hotdog rack 31, users can turn on the switch to drive the motor 6 as shown in FIGS. 8 and 9, such that the cylinders 30 can be driven and rotated by the gear 30 and the spike rod 11 or the basket hotdog rack 31 can be driven and rotated by the axle 61, so as to automatically turn over and heat the hotdogs and other food items on the cylinders 30, spiked rod 11, or basket hotdog rack 31 and prevent an uneven heating of the hotdogs. The overall structure is simple, and the manufacturing cost is low, and each module including the cylinders 30, the basket hotdog rack 31 and the spiked rod 11 can be removed from the oven 1 for cleaning, which constitutes an economic convenient household cooking apparatus.

In summation of the above description, the present invention enhances the performance of the conventional structure by cooking different food items in the same cooking apparatus at the same time to avoid the food from getting burned or becoming cold and providing a simple overall structure, a low cost for its manufacture, and a simple way for its cleaning, and further complies with the patent application requirements. The present invention is thus submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A household sectional oven and warmer cooking apparatus, comprising an oven, a meat slice and bread baking pan, a hotdog broiler, and a first door panel and a second door panel; wherein said oven is a baking tool comprising an electric heating device therein for adjusting and controlling a heating temperature and a heating time by a switch; an opening disposed at a top of said oven and another opening at a lateral side of said oven; a plurality of cylinders disposed in said opening at the top of said oven and embedded into an embedded groove or a flexible embedding hole at the periphery to form a hotdog broiler, such that said cylinders are removable, rotatable, and parallel with each other and disposed with an appropriate distance apart from each other; and said meat slice and bread tray is located in said opening at said lateral side of said oven; and said first door panel selectively covering said top opening of said oven, said second door panel selectively covering said opening in said lateral side of said oven.

2. The household sectional oven and warmer cooking apparatus of claim 1, wherein said hotdog broiler is embedded into flexible embedding holes disposed at the periphery of said oven by said cylinders.

3. The household sectional oven and warmer cooking apparatus of claim 1, wherein said electric heating device is installed directly in said each cylinder of said hotdog broiler, such that after said electric heating device is embedded into an embedded groove or an elastic embedding hole, said electric heating device is electrically connected with an internal circuit in a casing from a lateral side for producing heat energy from said cylinders after said switch is turned on.

4. The household sectional oven and warmer cooking apparatus of claim 1, wherein said hotdog broiler comprises a rotary basket hotdog rack.

5. The household sectional oven and warmer cooking apparatus of claim 1, wherein said oven installs a spiked mounting grid.

6. The household sectional oven and warmer cooking apparatus of claim 1, wherein said oven installs a motor for driving said cylinders and said basket hotdog rack to rotate by a gear.
